(19) United States
(12) Patent Application Publication
(10) Pub. No.: US 2009/0225090 A1
(43) Pub. Date: Sep. 10, 2009

(54) APPARATUS FOR ADJUSTING PARAMETERS OF DISPLAY CARD

(75) Inventors: Nai-Wei Chiu, Taipei (TW); Yu-Liang Liu, Taipei (TW); Hsiao-Chien Chien, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/041,670

(22) Filed: Mar. 4, 2008

(51) Int. Cl. G06F 13/14

(52) U.S. Cl. 345/520

(57) ABSTRACT

An apparatus for adjusting parameters of a display card is provided. The apparatus comprises a connecting interface, an input unit, a processing unit, and a display unit. The connecting interface is used for connecting the apparatus to the display card. The input unit is used for inputting an input frequency. The processing unit is used for detecting an adjustable frequency range of a graphic processing unit (GPU) in the display card and adjusting a working frequency of the GPU within the adjustable frequency range according to the input frequency. The display unit is used for displaying the working frequency of the display card. Therefore, the adjustment of parameters of the display card becomes more convenient and information of the display card can be obtained more easily.

### BACKGROUND OF THE INVENTION

1. Field of the Invention

The present invention relates to an apparatus for controlling a display card. More particularly, the present invention relates to an apparatus for adjusting and displaying parameters of a display card.

2. Description of Related Art

With the progress of software technology, 3D graphic technology has been extensively used for developing graphic software or games. Due to the enormous amount of 3D graphic data, a computer system needs to provide higher arithmetic power to meet the requirement for processing graphics in those graphic software or games.

However, the performance of running the graphic software is usually limited by the ability of processing graphics of the computer system. The insufficiency of computing resources not only affects the fluency of graphic software, but also leads to failure execution. To prevent the situation as mentioned above, the working frequency of a chip in the computer is raised to enhance the performance for executing the graphic software without upgrading the computer hardware. This technique is the so called overclocking.

Generally speaking, either a center processing unit (CPU) disposed in the computer or a graphic processing unit (GPU) disposed in a display card of the computer can be overclocked. As applied to 3D games, players may adjust the working frequency of the GPU by executing an overclocking program before playing the game so as to increase the performance of graphics processing and ensure the fluency of the 3D game. However, if the performance is still founded poor so that the working frequency is needed to be adjusted again during the execution of the 3D game, players have to exit the 3D game, adjust the working frequency by executing the overclocking program, and then execute the 3D game again. That means players have to repeat the redundant process every time they need to adjust the working frequency, which is not only time consuming but laborious.

Besides, since the 3D game is usually executed in full screen, it is hard for players to get the working frequency information of the GPU immediately. There is no additional place on the screen to display the working frequency information unless players stop executing the 3D game temporarily, and executes the overclocking program to get the latest working frequency information. As a result, adjusting and displaying the working frequency through the overclocking program can be very inconvenient.

### SUMMARY OF THE INVENTION

Accordingly, the present invention is directed to an apparatus for adjusting parameters of a display card. The apparatus reads the values of parameters of the display card and shows the value on the screen. Furthermore, the apparatus allows users to adjust the magnitude of parameters of the display card directly.

As embodied and broadly described herein, the present invention provides the apparatus for adjusting parameters of the display card, which includes a connecting interface, an input unit, a processing unit and a display unit. The connecting interface is suitable for connecting the apparatus to the display card. The input unit is suitable for inputting an input frequency. The processing unit is coupled to the connecting interface and the input unit and used for detecting an adjustable frequency range of a graphic processing unit (GPU) in the display card and for adjusting a working frequency of the GPU within the adjustable frequency range according to the input frequency. And the display unit is coupled to the processing unit and used for displaying the working frequency.

The apparatus for adjusting parameters of the display card according to an embodiment of the present invention, the processing unit adjusts the working frequency of the GPU from a predefined working frequency gradually, detects whether the GPU works abnormal. The processing unit stops the adjustment of the working frequency when the GPU is detected abnormal, and takes the adjusted working frequency as an adjustable frequency limit of the frequency adjustment range.

The apparatus for adjusting parameters of the display card according to an embodiment of the present invention, the processing unit detects whether a temperature of the GPU operating in the working frequency is higher than a predefined temperature to determine whether the GPU is abnormal.

The apparatus for adjusting parameters of the display card according to an embodiment of the present invention, the predefined working frequency comprises an initial working frequency of the display card set in a factory.

The apparatus for adjusting parameters of the display card according to an embodiment of the present invention, the processing unit further reads a plurality of parameters such as a GPU temperature, a current frames pre second (FPS), a system master volume, and a GPU fan speed of the display card through the connecting interface.

The apparatus for adjusting parameters of the display card according to an embodiment of the present invention, the input unit comprises a knob which is used for adjusting the magnitude of parameters when being rotated and for switching the parameter to be adjusted when being pressed.

The apparatus for adjusting parameters of the display card according to an embodiment of the present invention, the display unit further displays the GPU temperature, the current FPS, the system master volume, the GPU fan speed, and the GPU fan speed.

The apparatus for adjusting parameters of the display card according to an embodiment of the present invention, the input unit is further used for inputting an input volume, such that the processing unit adjusts the system master volume according to the input volume.

The apparatus for adjusting parameters of the display card according to an embodiment of the present invention, the input unit is further used for inputting an input fan speed, such that the processing unit adjusts the GPU fan speed according to the input fan speed.

The apparatus for adjusting parameters of the display card according to an embodiment of the present invention, the display card further comprises a connecting interface for connecting to the apparatus.

The apparatus for adjusting parameters of the display card according to an embodiment of the present invention, the apparatus is suitable for placing at the position of an optical disk driver (ODD) in a computer chassis.

The apparatus for adjusting parameters of the display card according to an embodiment of the present invention, the connecting interface comprises a universal serial bus (USB) interface or a cable bus interface.

The apparatus for adjusting parameters of the display card according to an embodiment of the present invention, the display card comprises a video graphic array (VGA) card.

The apparatus for adjusting parameters of the display card is used for directly reading and showing parameters of the display card, thus users are able to get the information of the display card at anytime. And the apparatus also provided a more convenient way for users to adjust parameters such as the working frequency of the GPU in the display card according to their requirement.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus of adjusting parameters of a display card.

FIG. 2 is a block diagram of a computer chassis.

FIG. 3 is a flow chart of adjusting a working frequency of a display card through the apparatus.

FIG. 4 is a flow chart of displaying parameters of a display card through the apparatus.

### DESCRIPTION OF EMBODIMENTS

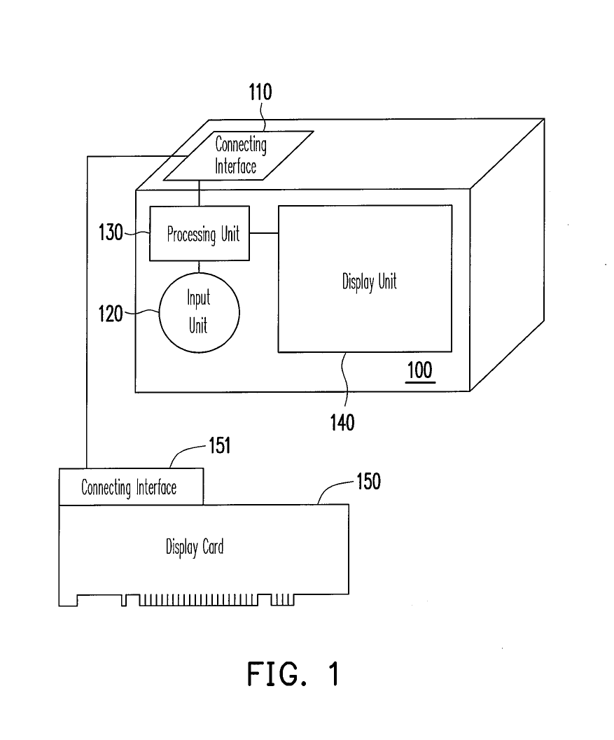

FIG. 1 is a block diagram of an apparatus for adjusting parameters of a display card according to one embodiment of the present invention. Referring to FIG. 1, the apparatus for adjusting parameters of a display card 100 includes a connecting interface 110, an input unit 120, a processing unit 130, and a display unit 140.

Through the connecting interface 110 and a connecting interface 151, the apparatus 100 is connected to a display card 150. In this embodiment, the display card 150 could be a video graphic array (VGA) card, and both of the connecting interface 110 and the connecting interface 151 could be universal serial bus (USB) interfaces or cable bus interfaces.

The input unit 120 is suitable for users to input parameters of the display card 150 such as an input frequency. The input unit 120 can be, for example, a knob which is used for adjusting the magnitude of parameters when being rotated and for switching the parameter to be adjusted when being pressed. In this embodiment, the parameters of the display card which can be adjusted by the user comprise the working frequency of the graphic processing unit (GPU), the system master volume, and the GPU fan speed.

The processing unit 130 is connected to the connecting interface 110 and the input unit 120. The magnitude of parameters of the display card 150 is read by the processing unit 130, and adjusted by the processing unit 130 according to the parameters inputted by the user through the input unit 120.

All of parameters of the display card 150 which are read by the processing unit 130 (e.g. the working frequency of the GPU, the GPU temperature, the current FPS, the system master volume, and the GPU fan speed) can be shown on the display unit 140, which is a LED screen, for example.

By using a stand-alone hardware such as the apparatus 100, parameters of the display card 150 can be directly adjusted instead of executing an overclocking program, thus the adjustment of parameters can be more convenient. In addition, those parameters of the display card 150 are also shown on a panel of the apparatus 100, such that current status of the display card 150 can be closely monitored.

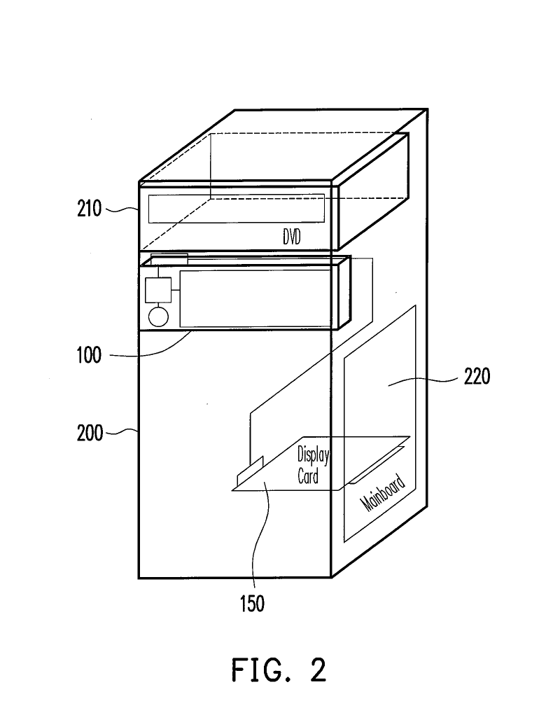

Referring to FIG. 2, generally speaking, there are several spaces in a computer chassis 200 for placing a disk device (not shown), a floppy (not shown), or a DVD 210. In this embodiment, the apparatus 100 for adjusting parameters of the display card 150 is suitable for placing at the position of an optical disk driver (ODD) in the computer chassis 200. And the apparatus 100 is connected to the display card 150 inserted in a mainboard 220 of the computer chassis 200. That means the apparatus 100 can be added in any existing computer of the user only through simple assembly and connection, which is quite flexible and convenient.

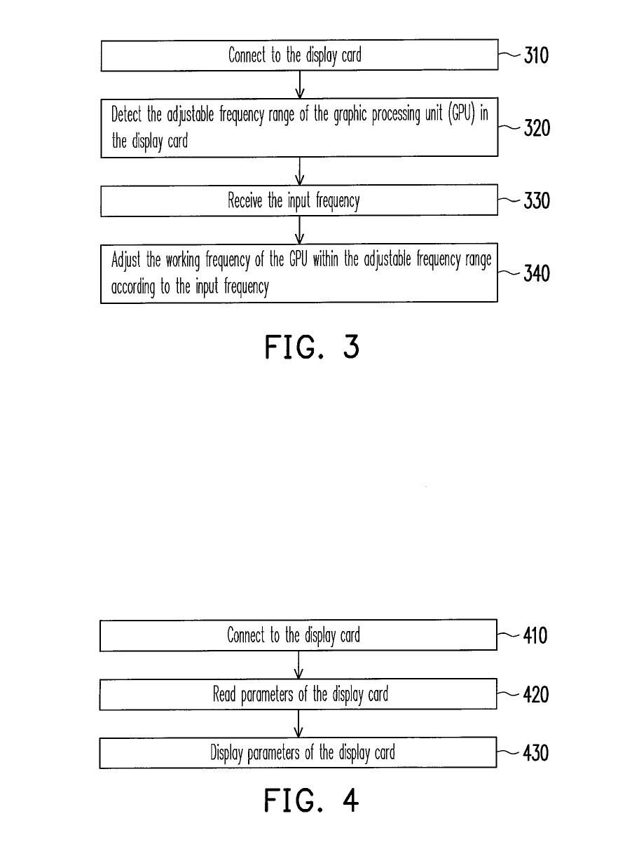

The following embodiment is going to illustrate the flow of adjusting the working frequency of the GPU by the apparatus 100. Referring to FIG. 1 and FIG. 3, in step 310, the apparatus 100 is connected to the display card 150 by the connecting interface 110 first. Next, in step 320, the processing unit 130 detects an adjustable frequency range of the GPU in the display card. In this embodiment, the processing unit 130 gradually adjusts the working frequency of the GPU from a predefined working frequency until the GPU is detected abnormal so as to locate a limit of the adjustable frequency range. That is, when a computer system with the display card is booted, the working frequency of the GPU is increasingly adjusted based on the predefined working frequency. The increment of the adjustment can be, for example, a certain percentage of original working frequency or a specific value, but not limited to them.

Then the processing unit 130 detects whether the GPU works abnormal by detecting the temperature of the GPU operating in the working frequency. If the temperature of the GPU is higher than a predefined temperature, the GPU is determined to be abnormal.

The processing unit 130 stops the adjustment of the working frequency when the GPU is detected abnormal, and takes the adjusted working frequency as the limit of the adjustable frequency range. The predefined working frequency in this embodiment comprises an initial working frequency of the display card 150 set in a factory.

In step 330, the apparatus 100 receives the input frequency which is input by a user through the input unit 120. In this embodiment, the input unit 120 can be a knob, and the user switches the parameter to be adjusted by pressing the knob, and adjusts the magnitude of the working frequency by rotating the knob.

Finally, in step 340, the processing unit 130 adjusts the working frequency of the GPU within the adjustable frequency range detected in step 220 according to the input frequency. In one embodiment, the working frequency of the GPU can be displayed on the display unit 140 after the adjustment is finished.

In another embodiment, by pressing the input unit 120 (e.g. a knob), the user is able to switch the parameter to be adjusted from the working frequency to the system master volume, such that the user is able to adjust the magnitude of the system master volume by rotating the input unit 120 in order to input an input volume. Consequently, the system master volume is adjusted by the processing unit 130 according to the input volume input by the user.

Similarity, in another embodiment, by operating the input unit 120 in the same way as described above, the user can switch the parameter to be adjusted to the GPU fan speed and adjust the magnitude of the GPU fan speed by the input unit 120. Therefore, the processing unit 130 adjusts the GPU fan speed according to an input fan speed input by the user.

Accordingly, users can adjust all kinds of parameters of the display card by simply operating a single input unit 120 of the apparatus 100. Thus the adjustment of parameters has become more flexible and easier.

It should be further noted that the apparatus 100 is not limited to only adjusting parameters of the display card. FIG. 4 is a flow chart of displaying parameters of the display card through the apparatus according to another embodiment of the present invention. That is, the user can not only adjust parameters of the display card 150 by the apparatus 100 but also get the information of the display card 150 through the apparatus 100.

Referring to FIG. 4, in step 410, the apparatus 100 is connected to the display card 150 by the connecting interface 110 and the connecting interface 151. Next, in step 420, parameters of the display card 150, such as the working frequency of the GPU, the GPU temperature, the current FPS, the system master volume, and the GPU fan speed, are read by the processing unit 130. Finally, in step 430, those parameters are shown on the display unit 140 of the apparatus 100. Therefore, with the help of the apparatus 100, the user may inspect the condition of the display card 150 at any time even when executing software or games, which is very convenient.

In view of the above, the present invention provides an apparatus adjusting parameters of a display card. According to the above embodiments, the present invention at least includes the following advantages.

1. By reading parameters of the display card and showing the magnitude of parameters, the user can immediately obtain the information of the display card through the apparatus.

2. The user can directly adjust parameters of the display card according to different requirement by the apparatus, thus the convenience of adjusting parameters can be improved.

3. Only a single input unit is necessary for users to switch parameters to be adjusted and adjust parameters, thus the operating process can be simplified and the convenience of using the apparatus can be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for adjusting parameters of a display card, comprising:
a connecting interface, suitable for connecting to the display card;
an input unit, suitable for inputting an input frequency;
a processing unit, coupled to the connecting interface and the input unit, suitable for detecting an adjustable frequency range of a graphic processing unit (GPU) in the display card, and adjusting a working frequency of the GPU within the adjustable frequency range according to the input frequency through the connecting interface; and
a display unit, coupled to the processing unit, suitable for displaying the working frequency.

2. The apparatus as claimed in claim 1, wherein the processing unit adjusts the working frequency of the GPU from a predefined working frequency gradually, detects whether the GPU works abnormal, stops the adjustment of the working frequency when the GPU is detected abnormal, and takes the adjusted working frequency as a limit of the adjustable frequency range.

3. The apparatus as claimed in claim 2, wherein the processing unit detects whether a temperature of the GPU operating in the working frequency is higher than a predefined temperature to determine whether the GPU is abnormal.

4. The apparatus as claimed in claim 3, wherein the predefined working frequency comprises an initial working frequency of the display card set in a factory.

5. The apparatus as claimed in claim 1, wherein the processing unit further reads a plurality of parameters such as a GPU temperature, a current frames pre second (FPS), a system master volume, and a GPU fan speed of the display card through the connecting interface.

6. The apparatus as claimed in claim 5, wherein the input unit comprises a knob which is used for adjusting the magnitude of parameters when being rotated and for switching the parameter to be adjusted when being pressed.

7. The apparatus as claimed in claim 5, wherein the display unit further displays the GPU temperature, the current FPS, the system master volume, the GPU fan speed, and the GPU fan speed.

8. The apparatus as claimed in claim 5, wherein the input unit is further used for inputting an input volume, such that the processing unit adjusts the system master volume according to the input volume.

9. The apparatus as claimed in claim 5, wherein the input unit is further used for inputting an input fan speed, such that the processing unit adjusts the GPU fan speed according to the input fan speed.

10. The apparatus as claimed in claim 1, wherein the display card is further comprised:
a connecting interface, suitable for connecting to the apparatus.

11. The apparatus as claimed in claim 1, wherein the apparatus is suitable for placing at the position of an optical disk driver (ODD) in a computer chassis.

12. The apparatus as claimed in claim 1, wherein the connecting interface comprises a universal serial bus (USB) interface.

13. The apparatus as claimed in claim 1, wherein the connecting interface comprises a cable bus interface.

14. The apparatus as claimed in claim 1, wherein the display card comprises a video graphic array (VGA) card.
